(19) United States
(12) Patent Application Publication
(10) Pub. No.: US 2016/0120146 A1
(43) Pub. Date: May 5, 2016

(54) PET TREAT DISPENSER WITH BEARING ACTUATED DOCKING STATION

(71) Applicants: Michael Parness, Foxfield, CO (US); Johnny Liao, Irvine, CA (US)

(72) Inventors: Michael Parness, Foxfield, CO (US); Johnny Liao, Irvine, CA (US)

(21) Appl. No.: 14/533,071

(22) Filed: Nov. 4, 2014

(51) Int. Cl. A01K 5/01; A01K 29/00; A01K 5/00

(52) U.S. Cl. CPC A01K 5/0114; A01K 5/00; A01K 29/00

(57) ABSTRACT

The invention comprises a novel pet treat dispenser and docking station wherein a ball sits in a docking station and a dog can rotate the ball to eject treats out of apertures located around the ball. The docking station is shaped such that treats or kibble will eject away from the ball and station and the dog can easily consume the treats. The ball may also easily be lifted from the station and rolled on a surface to further interest the dog and instill chase instinct.

### FIELD

The invention relates to a novel pet treat dispenser system wherein a dispenser shaped like a ball can rest in its docking station or be rolled independently. Treats dispense from orifices as the pet rolls the ball either in its docking station or on a surface.

### BACKGROUND OF THE INVENTION

The invention most closely corresponds with USPTO Class 119/702 wherein Class 119 relates to animal husbandry and sub-class 702 includes exercise or amusement devices for animals.

In its simplest form, the invention comprises a novel pet treat dispenser system wherein a dispenser shaped like a ball can rest in its docking station or be rolled independently. Treats dispense from orifices as the pet rolls the ball either in its docking station or on a surface.

It is well known in the animal behavior sciences that is a dog doesn't get the mental stimulation it needs it will develop behavior problems such as chewing, biting or elimination in the home due to boredom, stress or depression. Veterinary science has also determined that in addition to behavioral problems, a dog will also be more prone to diseases as the immune system can weaken due to stress or depression. Thus it is key to challenge a dog with activities such as the inventive toy and treat trainer.

### SUMMARY, OBJECTS AND ADVANTAGES

All who studied any form of psychology in school remember Pavlov's Dogs. A simple conditioning test resulted in dogs remembering or being cognitive of being given a treat when a bell was rung. Thus the dogs would respond in various cognitive ways when a bell was rung. This behavior presented itself for months after the actual tests were ceased. Pavlov evidenced that dogs actually had memory and the ability to react to certain stimuli on a consistent basis.

The inventive treat dispenser addresses the behavioral triggers which will challenge a dog and reward it when the behavior is repeated.

A docking station holds a ball-shaped treat dispenser with orifices from which treats or food kibble are ejected when the dog causes the ball to rotate. Bearings situated in the docking station provide a frictional surface so that the ball will rotate on the station and allow treats to be released from the ball when the orifice angles are rotated downward.

The ball may also be easily removed from the docking station so that a dog can roll the ball on a surface and cause treats or kibble to eject. This mode also encourages chase behavior that further interests the dog.

The docking station is concave so as to serve as a means to eject treats or kibble away from the ball when the ball is rotated in the station and treats eject from the orifices into the concave portion of the station. The ball is filled via a screw in or snap cap on one side of the ball. The cap will fit flush so as not to interfere with rotation of the ball.

### BRIEF DESCRIPTION OF THE DRAWINGS

The invention is described in further detail by reference to three (3) drawings sufficient in detail to describe the invention in which:

FIG. 1 is a side perspective view of the treat dispenser resting on the docking station;

FIG. 2 is an aerial perspective of the treat dispenser with the bearings in phantom; and

FIG. 3 is an illustration of a dog causing to dispenser to roll in the docking station.

### DETAILED DESCRIPTION, INCLUDING BEST MODES OF CARRYING OUT THE INVENTION

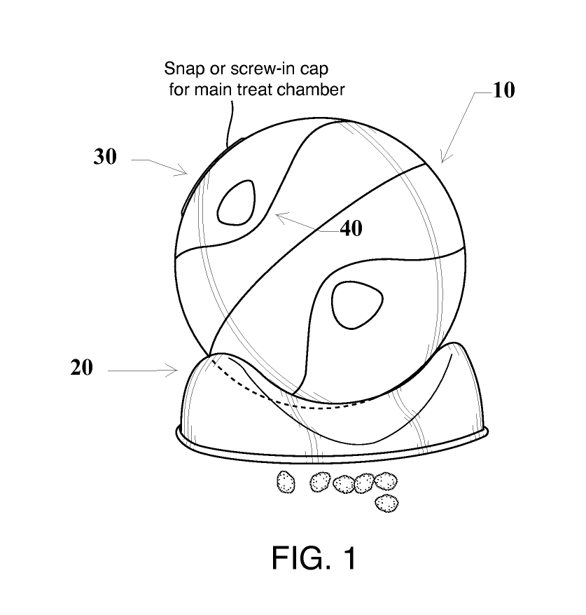

FIG. 1 illustrates the treat dispenser 10 in the docking station 20. A snap cap 30 is located on one side of the ball for a user to fill the ball with treats or kibble. Orifices 40 allow for dispensing treat or kibble when the ball is rotated accordingly.

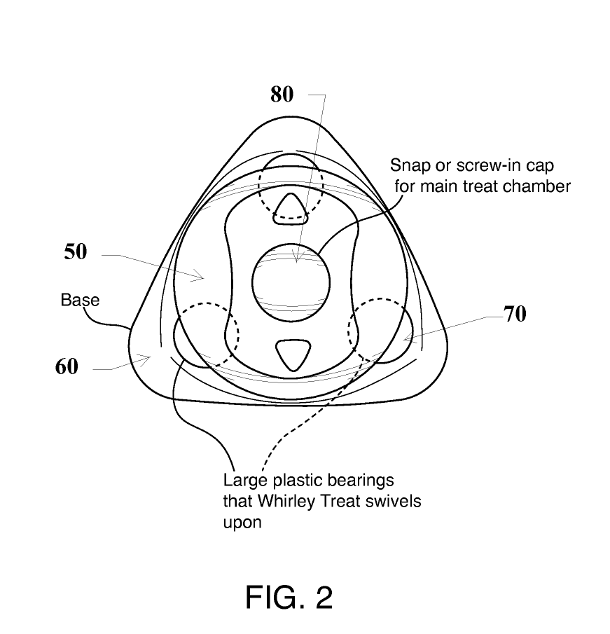

FIG. 2 is an aerial view of the treat dispenser 50 and the docking station 60. Large plastic bearings 70 are located at three points along the docking station to provide frictional means for the ball to rotate yet remain in the station. The filling means 80 is a hole on one side of the ball wherein a snap or screw cap will sit flush to the outer portion of the ball so as not to impede rotation.

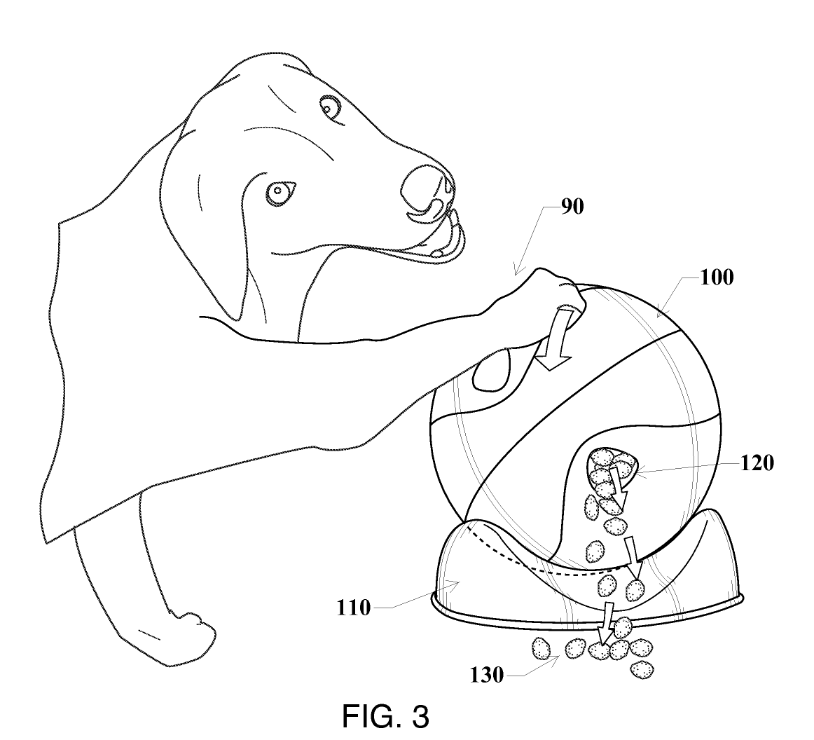

FIG. 3 illustrates a dog 90 applying pressure so that the ball 100 rotates in the docking station 110. Orifices 120 for treat or kibble dispensing are located around all sides of the ball so that they will dispense when a dog rotates the ball in a manner such that the orifices point downward and allow simple gravity to eject the treats. The treats roll out the orifice and are ejected away from the docking station 130 so that the dog can more easily consume them and so as not to impede continued rotation of the dispenser.

1) A pet treat dispenser and docking station comprising;
a) a ball with apertures spaced around said ball
b) a docking station
c) plastic bearings
d) a fill cap and orifice therefor

2) A pet treat dispenser and docking station as in claim 1 wherein the ball is hollow and has apertures or openings from which food or kibble can eject.

3) A pet treat dispenser and docking station as in claim 1 wherein a docking station holds the ball in a cradle like manner and wherein the top side of the station is concave.

4) A pet treat dispenser and docking station as in claim 1 wherein plastic bearings are located in the docking station to provide friction for the ball to be rotated upon while in the station.

5) A pet treat dispenser and docking station as in claim 1 wherein the ball contains one opening larger than the other apertures wherein treats or kibble are inserted into the hollow ball and wherein a screw or snap on cap fits flush to the outer walls of the ball when inserted.
